(19) United States
(12) Patent Application Publication
(10) Pub. No.: US 2012/0081286 A1
(43) Pub. Date: Apr. 5, 2012

(54) ALERTING USER TO SHORTCUTS ON COMPUTER

(75) Inventors: Sean Patrick Kennedy, San Diego, CA (US); Fredrik Carpio, San Diego, CA (US); Rommel Garay, San Marcos, CA (US); Paul Jin Hwang, Solana Beach, CA (US); Gary Robert Lyons, San Diego, CA (US); Edward Theodore Winter, San Diego, CA (US); Christopher Mark Ohren, San Diego, CA (US); Michael Chang, San Diego, CA (US); Andrew Lee Lawton, San Marcos, CA (US); Scott Avery Patton, Escondido, CA (US)

(73) Assignee: SONY CORPORATION

(21) Appl. No.: 12/898,161

(22) Filed: Oct. 5, 2010

(51) Int. Cl. G06F 3/02

(52) U.S. Cl. 345/168

(57) ABSTRACT

Keypad keys having functions when they are pressed simultaneously with a meta key are backlit or bear indicia indicating the functions. A user interface (UI) can be presented indicating the functions of the keys. A row of special purpose keys user-programmable can be provided with each key invoking a respective application of service.

### FIELD OF THE INVENTION

The present application relates generally to alerting users of shortcuts on computers and in particular of shortcut keystrokes of which a user otherwise might not be aware.

### BACKGROUND OF THE INVENTION

As computers grow ever more sophisticated they provide a host of capabilities, applications, etc. not all of which may be apparent to the user. Some of the capabilities may be complex and some relatively simple but useful, but regardless, owing to the large number of them many capabilities go unnoticed and thus unexploited by the user.

As an example, the operating system (OS) executed by the processor of the computer can provide many simple but useful functions including keyboard shortcuts that may be invoked by pressing a special key such as a meta key (sometimes established by a “Windows Key” or “WinKey” located in the bottom row of most keyboards on the left side between the “control” and “alt” keys) simultaneously with another key typically corresponding to a letter. A user temporarily leaving his computer while in a non-secure place, for instance, can simultaneously press the WinKey with the “L” key to lock the computer, bringing up a password entry screen into which a password must be entered to resume operation. Other keys pressed simultaneously with the WinKey can have other functions but most users have no idea that these functions exist.

### SUMMARY OF THE INVENTION

Accordingly, a computing device has a processor, a video display controlled by the processor, and a keypad communicating with the processor to send user selection signals to the processor. The keypad includes a meta key and plural character keys. First character keys have respective functions apart from entry of their respective character when pressed simultaneously with the meta key, while second character keys have no respective functions apart from entry of their respective character when pressed simultaneously with the meta key. Visual indication is provided on each first character key of its respective function when pressed simultaneously with the meta key.

In some embodiments each of the first and second character keys bears respective character indicia representing the respective character they respectively represent when pressed individually. The second character keys but not the first character keys can bear respective meta key function indicia representing their respective functions when pressed simultaneously with the meta key. The meta key function indicia may be icons or words.

Alternatively or in addition to the meta key function indicia, the second character keys but not the first character keys can be backlit by respective backlight lamps underlying a transparent or translucent key substrate on the top surface of which appears the respective character index. If desired, all backlit keys can be illuminated with the same color as each other or backlit keys are illuminated with respective different colors representing their respective functions when pressed simultaneously with the meta key.

In another aspect, a computing device has a processor, a video display controlled by the processor, and a keypad communicating with the processor to send user selection signals to the processor. The keypad includes a meta key and plural character keys. First character keys have respective functions apart from entry of their respective character when pressed simultaneously with the meta key, while second character keys have no respective functions apart from entry of their respective character when pressed simultaneously with the meta key. The processor presents a user interface (UI) on the display which lists the function each first character key has when pressed simultaneously with the meta key.

In another aspect, a computing device has a processor, a video display controlled by the processor, and a keypad communicating with the processor to send user selection signals to the processor. The keypad includes plural single purpose keys that, when manipulated, invoke respective software applications or services.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing interior components of the computer;

FIG. 2 is a plan view of a simplified example keyboard in accordance with present principles;

FIG. 3 is an elevational view of a key as seen along the line 3-3 in FIG. 2;

FIG. 4 is a screen shot of an example user interface (UI) to inform a user of double press shortcut functions;

FIG. 5 is a flow chart of example logic that may be used during an out of box experience (OOBE);

FIG. 6 is a flow chart of additional example logic that may be used during an out of box experience (OOBE); and

FIG. 7 shows a hotkey user interface.

### DETAILED DESCRIPTION OF THE PREFERRED EMBODIMENT

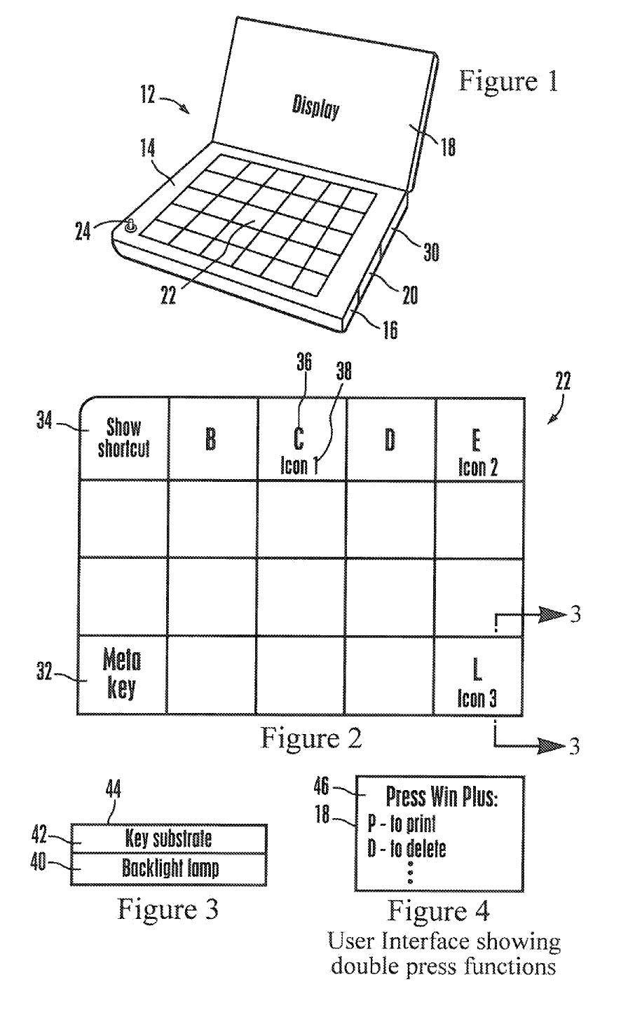

Referring initially to FIG. 1, a computing device 12 such as a personal digital assistant, laptop computer, personal computer (PC), etc. includes a housing 14 bearing a digital processor 16. The processor 16 can control a visual display 18 and an audible display such as one or more speakers. The processor 16 may access a media player module such that the device 12 has media decoding capability.

To undertake present principles, the processor 16 may access one or more computer readable storage media 20 such as but not limited to RAM-based storage, a chip implementing dynamic random access memory (DRAM)) or flash memory or disk storage. Software code implementing present logic executable by the device 12 may be stored on one of the memories shown to undertake present principles.

The processor 16 can receive user input signals from various input devices, including a keyboard or keypad 22 (hereinafter “keypad” without loss of generality), a point and click device such as a mouse or joystick 24, etc. “Keypad” without additional modifiers is intended to cover any keyed computer input device suitable for purposes below and including multiple keys corresponding to letters, numbers, and non-alphanumeric characters, usually arranged for English speaking countries in a QWERTY layout but having other possible key arrangements as well. A network interface 30 such as a wired or wireless modem or wireless telephony transceiver may also be provided and may communicate with the processor 16.

FIG. 2 shows details of the keypad 22, simplified for ease of disclosure. Among the keys shown is a meta key 32, referred to in some implementations as a WinKey. Keys other than the WinKey may establish a meta key. In any case, the meta key 32 is shown in the bottom left part of the keypad 22 but it is to be understood that its position with respect to the other keys is not limiting unless otherwise stated.

As describe above the keypad 22 may be a QWERTY keypad but for simplicity only a few keys are labeled in the top row and discussed herein. A “show shortcuts” key 34 may be provided for purposes discussed below. Also, the letter keys “B”, “C”, “D”, “E”, and “L” are shown. Assume that the letter keys “B” and “D” have no functions when pressed simultaneously with the meta key 32 but that the letter keys “C”, “E”, and “L” do have respective functions when pressed simultaneously with the meta key 32 apart from simple entry of their respective characters into the processor 16.

In one implementation given the above example, those keys having functions when pressed simultaneously with the meta key 32 include respective character indicia 36 representing the character they respectively represent when pressed individually and respective meta key function indicia 38 representing their respective functions when pressed simultaneously with the meta key 32. Thus, for example, the “L” key may have an “L” character on it as shown as well as an index such as an icon appearing as a padlock, to represent its locking function when pressed simultaneously with the meta key 32. The respective meta key function index 38 representing a key's respective function when pressed simultaneously with the meta key 32 may be a word such as, in the example case of the letter “L”, the word “lock”.

In another implementation, as in the embodiment above those letters having functions when pressed simultaneously with the meta key 32 include character indicia 36 representing the character they respectively represent when pressed individually, just as other keys, but no separate meta key function index is inscribed on the letters having functions when pressed simultaneously with the meta key 32. Instead, those keys having functions when pressed simultaneously with the meta key 32 are backlit by illuminating a respective backlight lamp 40 underlying a transparent or translucent key substrate 42 (FIG. 3) on the top surface 44 of which appears the key's character index. Keys not having functions when pressed simultaneously with the meta key 32 are not backlit. All backlit keys may be illuminated with the same color or with different colors representing their respective functions when pressed simultaneously with the meta key 32. In both embodiments it will be appreciated that an indication (e.g., the meta key function indicia 38 or the backlighting) is visible on each key having a function when pressed simultaneously with the meta key 32 indicating such, along with the key's character index 36.

In one example, an example compound action can be simultaneously pressing the meta key with the control key which then shows another set of options via backlighting, e.g., pressing the meta key with the control key can cause backlighting to be illuminated under the tab key, number keys, etc.

Principles above can apply to meta keys other than the WinKey, e.g., to function keys typically arranged in a top row of many keypads. Or, only those function keys having Fn Functions (e.g., F5, F6, F7, Up, Down, Left, Right, etc.) are backlit while unused function keys are not backlit.

In yet another embodiment or in addition to the visual feature described above, a user interface (UI) such as the UI 46 shown in FIG. 4 may be presented on the display 18, e.g., in response to a user pressing the “show shortcut” key 34 in FIG. 2, which lists the function each key has when pressed simultaneously with the meta key.

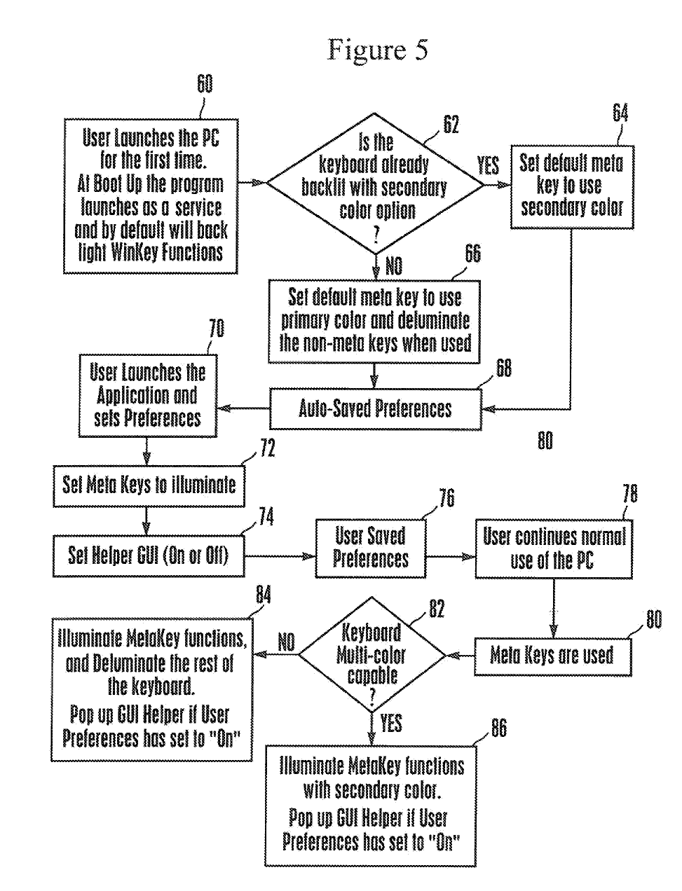

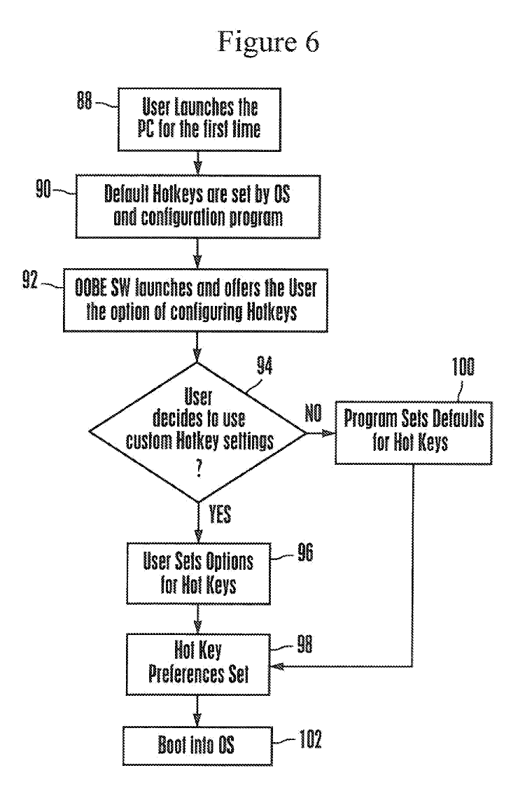

As contemplated herein, a user can be allowed to manually configure keys during an out of box experience (OOBE), i.e., the first time the computer is energized after purchase. FIGS. 5 and 6 illustrate example implementations.

Commencing at block 60, at OOBE (first time launch of the computer) a service is launched at boot up that by default backlights the keys which have functions when pressed simultaneously with the meta key. Decision diamond 62 indicates that when the keypad is already backlit with a secondary color option, the logic moves to block 64 to set the default meta key to use the secondary color; otherwise, the logic flows to block 66 to set the default meta key to use a primary color and to remove back lighting from non-meta keys. These preferences are saved at block 68.

Proceeding to block 70, a user input signal is received indicating that the user launches the application and sets preferences. The keys having special functions when pressed with the meta key are illuminated at block 72, and then at block 74 the helper GUI of FIG. 4 (explaining functions of keys when pressed along with the meta key) is set to on or off under control of a user-input signal. The user preferences are saved at block 76.

Block 78 simply indicates that the user continues normal use of the computer, and when the meta key is used at block 80 it is determined at decision diamond 82 whether the keys of the keypad are capable of being back-illuminated in more than a single color. If not, the keys having special functions when pressed with the meta key are illuminated at block 84 and all other keys are de-illuminated. If the GUI of FIG. 4 has been set to “on” it is presented on the display. On the other hand, if the keys of the keypad are capable of being back-illuminated in more than a single color the logic flows from decision diamond 82 to block 86 to illuminate with a secondary color keys having special functions when pressed with the meta key, with other keys being illuminated with a primary color. If the GUI of FIG. 4 has been set to “on” it is presented on, the display.

Now turning to FIG. 6, at block 88 the user launches the computer for the first time. Proceeding to block 90 the processor 16 executing the operating system of the computer and a hot key configuration program sets default, hot keys. The software executed at the OOBE then offers the user, by way of a user interface, the option of configuring the hot keys.

A user input is received from the UI and at decision diamond 94 it is determined whether the input indicates that the user wishes to customize the hotkey settings. If so, the logic flows to block 96 to receive user input defining functions for the hotkeys, which are saved at block 98. Otherwise, the default functions for the hotkeys are set at, block 100 and saved at block 98. The hotkey functions are then booted into the operating system at block 102 for future execution when the relevant hotkeys are pressed.

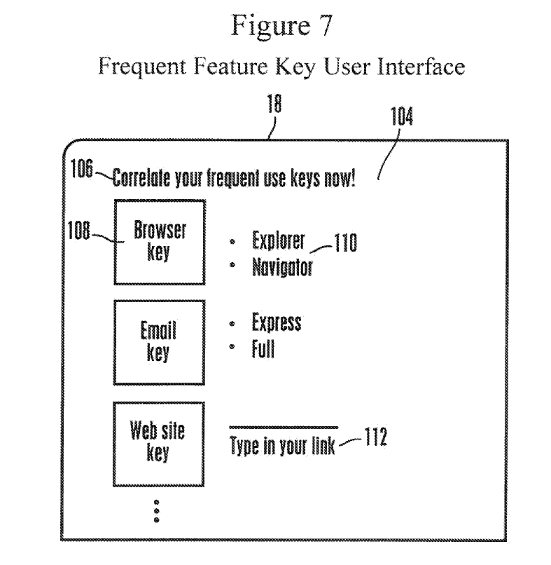

FIG. 7 shows an example hotkey setup UI 104. As shown, a prompt 106 may encourage the user to establish the functions of hotkeys. Images 108 of the hotkeys may be presented along with entry tools 110, e.g., menus of available applications/services that may be used for that key. Thus, for example, beside the image corresponding to a browser key, a menu listing two possible browsers to be invoked when the browser key is pressed is shown. A user selects, by means of, e.g., one of the input devices described above, an entry from the menu (block 96 in FIG. 6) and responsive to that selection, the processor 16 thereafter invokes the selected browser whenever the browser key is pressed.

Similarly, beside the image corresponding to an email key, a menu listing two possible email applications to be invoked when the email key is pressed is shown, from which the user can select a preferred email application that the processor 16 thereafter invokes whenever the email key is pressed.

In the case of a favorite site key, beside the image corresponding to it may be an entry tool established by a field into which the desired website's address can be typed, along with a prompt 112 to do so. In any case, the applications and services invoked by the hotkeys may be established by the user as desired.

While the particular ALERTING USER TO SHORTCUTS ON COMPUTER is herein shown and described in detail, it is to be understood that the subject matter which is encompassed by the present invention is limited only by the claims.

What is claimed is:

1. Computing device comprising:
processor;
video display controlled by the processor;
keypad communicating with the processor to send user selection signals to the processor, the keypad including at least one meta key and plural character keys, first character keys having respective functions apart from entry of their respective character when pressed simultaneously with the meta key, second character keys having no respective functions apart from entry of their respective character when pressed simultaneously with the meta key, visual indication being provided on each first character key of its respective function when pressed simultaneously with the meta key.

2. The computing device of claim 1, wherein each of the first and second character keys bears respective character indicia representing the respective character they respectively represent when pressed individually.

3. The computing device of claim 2, wherein the second character keys but not the first character keys bear respective meta key function indicia representing their respective functions when pressed simultaneously with the meta key.

4. The computing device of claim 3, wherein the meta key function indicia are icons.

5. The computing device of claim 3, wherein the meta key function indicia are words.

6. The computing device of claim 2, wherein the second character keys but not the first character keys are backlit by respective backlight lamps underlying a transparent or translucent key substrate on the top surface of which appears the respective character index.

7. The computing device of claim 6, wherein all backlit keys are illuminated with the same color as each other.

8. The computing device of claim 6, wherein backlit keys are illuminated with respective different colors representing their respective functions when pressed simultaneously with the meta key.

9. Computing device comprising:
processor;
video display controlled by the processor;
keypad communicating with the processor to send user selection signals to the processor, the keypad including at least one meta key and plural character keys, first character keys having respective functions apart from entry of their respective character when pressed simultaneously with the meta key, second character keys having no respective functions apart from entry of their respective character when pressed simultaneously with the meta key, wherein the processor:
presents a user interface (UI) on the display which lists the function each first character key has when pressed simultaneously with the meta key.

10. The computing device of claim 9, wherein the UI is presented in response to a user pressing a “show shortcut” key.

11. Computing device comprising:
processor;
video display controlled by the processor;
keypad communicating with the processor to send user selection signals to the processor, the keypad including plural single purpose keys that, when manipulated, invoke respective software applications or services.

12. The device of claim 11, wherein the processor presents on the display a user interface (UI) configured to permit a user to correlate each single purpose key with a respective software application or service.

13. The device of claim 12, wherein the UI is presented during an out of box experience (OOBE).

14. The device of claim 12, wherein the UI includes images of at least some single purpose key along with an entry tool usable to correlate the respective single purpose key with an application or service, the entry tool being a menu of available applications/services that may be used for the single purpose key corresponding to the respective image on the UI.

15. The device of claim 12, wherein the UI includes images of at least some single purpose key along with an entry tool usable to correlate the respective single purpose key with an application or service, the entry tool being a field into which a website address can be typed.

16. The device of claim 11, wherein second character keys but not first character keys are backlit by respective backlight lamps underlying a transparent or translucent key substrate on the top surface of which appears the respective character index.

17. The device of claim 16, wherein all backlit keys are illuminated with the same color as each other.

18. The device of claim 16, wherein backlit keys are illuminated with respective different colors representing their respective functions when pressed simultaneously with the meta key.
